(19) United States
(12) Patent Application Publication
(10) Pub. No.: US 2010/0099495 A1
(43) Pub. Date: Apr. 22, 2010

(54) INTERACTIVE NETWORK GAME AND METHODS THEREOF

(75) Inventor: Aaron Brady, San Jose, CA (US)

Correspondence Address: LARSON NEWMAN & ABEL, LLP, 5914 WEST COURTYARD DRIVE, SUITE 200, AUSTIN, TX, 78730, US

(73) Assignee: NC INTERACTIVE, INC., Austin, TX (US)

(21) Appl. No.: 12/252,752

(22) Filed: Oct. 16, 2008

(51) Int. Cl. A63F 9/24; G06F 19/00

(52) U.S. Cl. 463/42; 463/43

(57) ABSTRACT

A method of instantiating a player-versus-player match at a network game includes creating a private region of a publicly accessible game environment. User-customized buildings are instantiated in the private region. Each building is based on configuration information provided by a game participant, so that each building represents a unique building associated with a particular user or user group. A player-versus-player match is initiated in the private region, so that participants in the match can interact with the customized buildings.

### FIELD OF THE DISCLOSURE

The present disclosure relates to networked games and more particularly to game modes for networked games.

### BACKGROUND

Interactive online environments, such as multiplayer online games, have become increasingly popular in recent years. In such environments, an avatar, such as a game character, typically represents a participant in the online environment. The participant interacts with the online environment by manipulating the avatar. For example, by moving the avatar through the online environment, the participant can explore the environment. Interactions with the online game can take the form of the in-game character fighting, communicating, or otherwise interacting with computer controlled characters and events. Other interactions can take the form of battles or other interactions between characters. The user experience with a network game can be improved by enhancing the immersivity and flexibility of the game environment.

### BRIEF DESCRIPTION OF THE DRAWINGS

The present disclosure may be better understood, and its numerous features and advantages made apparent to those skilled in the art by referencing the accompanying drawings.

FIG. 1 illustrates a block diagram of a communication system 100 in accordance with one embodiment of the present disclosure.

FIG. 2 illustrates a diagram of a particular embodiment of a building object of FIG. 1.

FIG. 3 illustrates a diagram of a publicly accessible network game environment in accordance with one embodiment of the present disclosure.

FIG. 4 illustrates a diagram of a private player-versus-player region of a network game environment in accordance with one embodiment of the present disclosure.

FIG. 5 illustrates a flow diagram of a method of initiating a player-versus-player match in a network game environment.

The use of the same reference symbols in different drawings indicates similar or identical items.

### DETAILED DESCRIPTION

A method of instantiating a player-versus-player match at a network game includes creating a private region of a publicly accessible game environment. User-customized buildings are instantiated in the private region. Each building is based on configuration information provided by a game participant, so that each building represents a unique building associated with a particular user or user group. A player-versus-player match is initiated in the private region, so that participants in the match can interact with the customized buildings.

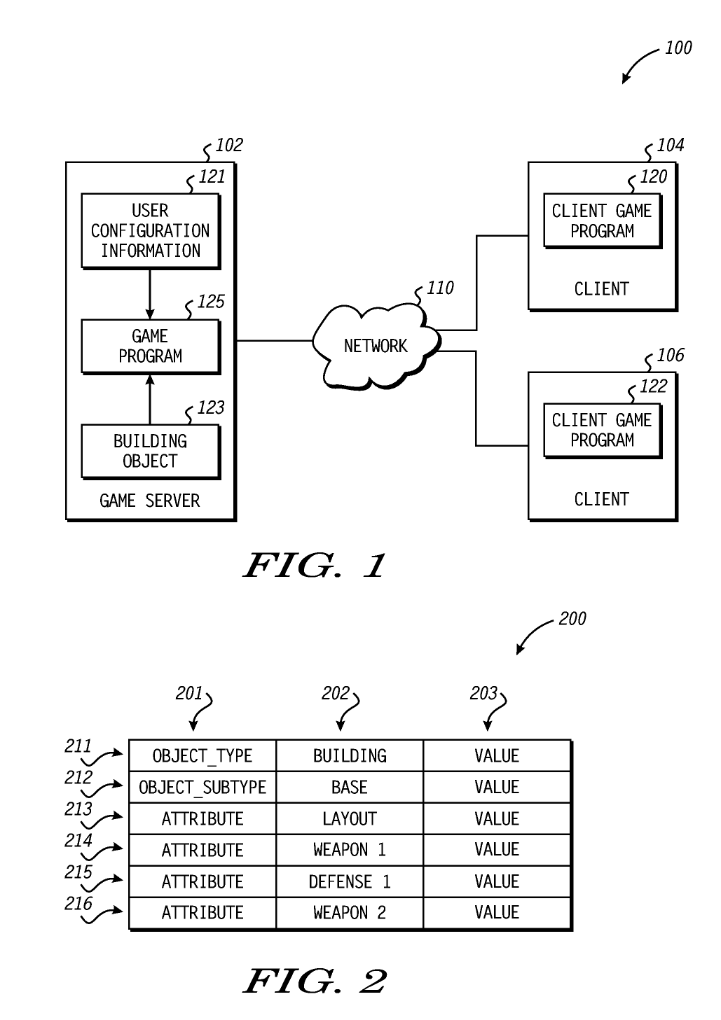

FIG. 1 illustrates a block diagram of a communication system 100 in accordance with one embodiment of the present disclosure. The communication system 100 includes a wide area network 110 connected to a game server 102 and client devices 104 and 106. The wide area network 110 can be a packet switched network that provides a physical communication layer to route packets between the game server 102 and the client device 104 and 106. In an embodiment, the wide area network 110 is the Internet.

The game server 102 is a computer device, such as a computer configured as a server device, which executes a game program 125. The game program 125 interacts with a game program 120 and a game program 122 at the client devices 104 and 106, respectively, to create an online gaming environment. To illustrate, the game program 125 includes a number of game objects, including building object 123. The game objects can represent any object in the online game, including game avatars, non-player characters, environmental objects, and the like.

The game program 125 is configured to instantiate or terminate game objects based on communications received via the wide-area network 110. Such communications indicate game activity from participants in the game. Thus, as new participants are added to a game session, the game program 125 instantiates new objects representing avatars for the new participants. As participants leave the game, the game program 125 can eliminate game objects representing avatars for the leaving participants. In addition, the game program 125 can change attributes of the game objects based on participants' interactions with objects in the game. For example, the game program 125 can change positional attributes of game objects based on a participant manipulating the objects with his avatar, or based on the position of the objects changing relative to the avatar.

To illustrate, in a particular embodiment a game object is a sword. The game program 125 can receive communications indicating a participant's avatar has picked up the sword. In response, the game program 125 changes attributes of the game object to indicate the sword is usable by the participant's avatar. As the sword is used by the avatar, the game program 125 can change the attributes of the game object to represent aging of the sword or damage to the sword. These attribute changes can change the way the game object 110 interacts with other game objects. For example, as the sword ages, it may cause less damage to a non-player character in combat.

Based on the game objects, the game program 125 is configured to communicate data about the gaming environment via the wide area network 110 to the client devices 104 and 106. This allows participants at the client devices 104 and 106 to participate in a common game environment, so that one participant's interactions with the environment can affect the gaming experience of the other participant.

The game programs 120 and 122 are configured to provide a display of the gaming environment and an interface for a participant to interact with the environment. For ease of discussion, the configuration of the game program 120 will be described, but it will be appreciated that the game program 122 can be configured similarly.

The game program 120 sends communications via the wide area network 110 to the game server 102 indicating the position of an avatar associated with a participant of the game. To illustrate, the game program 120 provides an interface for a participant to enter (i.e. login to) the game. The participant enters authentication information, such as a password, and selects a particular avatar to represent the participant in the game environment. The game program 120 determines the position of the avatar in the game environment. When the participant first logs in, this position can be a predetermined initial position, a previously saved position, and the like. The game program 120 communicates the determined position to the game program 125 at the game server 102.

In response to receiving the positional data, the game program 125 determines which game objects are viewable or otherwise available for interaction by the participant's avatar. These game objects can include the avatars of the other participants. The game program 125 provides attribute information about the game objects to the game program 120 via the wide area network 110. The game program 125 can provide additional information, such as information about the participant's avatar (e.g. inventory information, health information, class information, and the like). Based on the received object information, the game program 120 provides a visual display representative of the game environment. In an embodiment, the game environment is displayed in a three-dimensional representation. As used herein, a three-dimensional representation refers to a representation that can be displayed on a two-dimensional display, but appears to be a three-dimensional object or environment. The game program 120 ensures that as an avatar moves through the game environment, the display of the environment is updated such that the environment appears three-dimensional. Accordingly, the game program 120 displays each game object so that the object appears three-dimensional in the game environment.

In the illustrated embodiment of FIG. 1, the game server 102 stores user configuration information 121. Based on the game configuration information 121, the game program 125 can configure one or more game objects. In an embodiment, the game program 125 can provide an interface, such as a graphical user interface (GUI) to allow a game participant to modify the user configuration information, thereby customizing the attributes of designated in-game objects. For example, in one embodiment, the game program 125 can use the game configuration information 121 to determine the attributes of an avatar associated with a game participant. The game program 125 can determine an avatar's appearance, costume, and other visual aspects of the avatar based on the user configuration information 121. Accordingly, by modifying the user configuration information 121 via the interface provided by the game program 125, a game participant can modify the appearance of an avatar associated with the participant.

As illustrated in FIG. 1, the game server 102 stores a building object 123, representative of an in-game building. As used herein, an in-game building refers to a portion of a game environment representative of an indoor environment, such as a house, group base, and the like. Further, as used herein, an in-game building refers to only a portion of the game environment, such that in-game characters are able to enter the building from and exit the building to other outdoor or non-building environments.

An example of a data structure 200 associated with the building object 123 is illustrated at FIG. 2. As illustrated, the data structure 200 includes a number of fields, such as a data class field 201, a data type field 202, and a data value field 203. The data class field 201 identifies a particular class of information associated with a game object, the data type field 202 indicates a type of information associated with indicated class, and the data value field 203 indicates information indicating a selected one of possible data types. Thus, each row of the data structure 200 indicates a particular characteristic of the building object 123 based on data stored at each field. For example, row 211 of the data structure indicates an object type for the building object 123. In particular row 211 indicates that building object 123 has an object type of “Building.” The value field for row 211 can indicate further information about the object type, such as a particular game region or in-game character associated with the building object 123.

Row 212 indicates an object subtype. In the illustrated embodiment of FIG. 2, row 212 indicates that building object 123 is a “base” type of building object (e.g. a building object that can be employed by one or more in-game characters as a base of operations). The value field for row 212 can indicate further information, such as a type of base, selected from a range of specified base types, associated with the building object 123. Rows 212, 213, 214, and 215 indicate attribute information for the building object 123. In particular row 213 defines a layout attribute for the building object 123. As used herein, a layout of an in-game building refers to the arrangement of rooms in the in-game building as displayed in the game environment. The value field associated with row 213 can indicate information about the layout, such as indicating a data file or other collection of information that defines the layout for the building object 123. Rows 213-215 define other aspects of the building object 123. For example, row 213 and 215 each define an in-game weapon located at the in-game building, while row 214 defines an in-game defense option located at the in-game building. The values associated with each row define a selected option for the associated attribute. For example, the value associated with row 213 indicates a particular type of in-game weapon selected from a specified set of options.

The user configuration information 121 can customize the appearance and in-game functions of the building object 123 by setting values for one or more of the attributes of the data structure 200. Thus, the user configuration information 121 can determine a layout of the in-game building associated with the building object, in-game weapons and defenses present at the in-game building, and the like. Accordingly, a user can customize the layout of an in-game building, weapons and defenses present, and other aspects, by customizing the user configuration information 121.

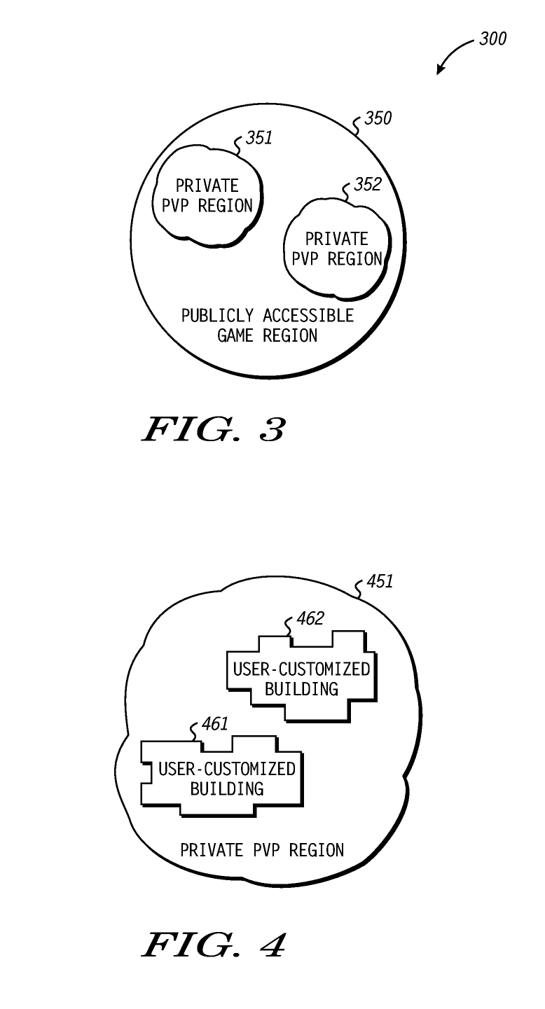

Referring to FIG. 3, a diagram of a particular embodiment of a publicly-accessible game environment 300 is illustrated. In the illustrated embodiment, the publicly-accessible game environment 300 includes a publicly accessible game region 350, representing an in-game region that can be accessed by any game participant. The publicly accessible game environment 300 further includes private “player-vs.-player” (PVP) regions, such as private PVP regions 351 and 352. Each PVP region represents an area of the publicly accessible game environment designated for private player-vs.-player or group-vs.-group game events. In such PVP events game participants, or groups of game participants, can engage in in-game combat, quests, and other events with other participants through their in-game avatars.

Each PVP region 351 and 352 is isolated from the publicly-accessible game region 350 in some fashion. For example, the PVP regions 351 and 352 can be located in a location that is remote from areas frequented by participants in the publicly accessible game region 350, so that having an in-game avatar travel to the private PVP regions 351 and 352 is difficult or impossible. By isolating the PVP regions 351 and 352, the PVP matches can provide a customized experience for the game participants without interference from players not associated with the match.

In an embodiment, the PVP regions 351 and 352 can be instantiated in response to a player request for a PVP match. In one embodiment, the PVP region 351 is instantiated by designating a portion of the publicly accessible game region as a private space for the duration of the match. In addition, customized game conditions, objectives, environmental attributes, and the like, can be created for each instantiated PVP region to provide for a customized game experience. In particular, customized in-game buildings can be instantiated in each PVP region, allowing players to interact with the customized buildings during a PVP match. This can be better understood with reference to FIG. 4.

FIG. 4 illustrates a particular embodiment of a private PVP region 451, corresponding to the private PVP region 351 of FIG. 3. As illustrated in FIG. 4, the PVP region 451 includes user-customized buildings 461 and 462, each of which has been configured by a user. In an embodiment, each of the user-customized buildings has been customized in similar fashion to that described above with respect to FIGS. 1 and 2.

By allowing the game participants to create user-customized buildings and use them in PVP matches, a more immersive in-game experience can be created. For example, in the illustrated embodiment of FIG. 4, the user-customized buildings 461 and 462 can each represent a player base for a game participant or group of game participants. The object of the PVP match can be to retrieve an object from the opposing group's base, control a portion of the opposing group's base, destroy a portion of the opposing group's base, and the like. Because the bases are customized building objects, the game experience itself is customized. For example, a user can customize his base so that is easier to defend, so that it reflects an aspect of the group's personality or mission, and the like.

Upon completion of the PVP match, the instantiation of the private PVP region 451, including the user-customized buildings 461 and 462, can be terminated, allowing the region to be available for new PVP matches. In an embodiment, changes to the user-customized buildings resulting from the PVP match can be recorded, so that subsequent instantiations of the user-customized building will reflect the changes. For example, if a user-customized building is damaged during a PVP match, this damage can be indicated by changing aspects of the user configuration information associated with the building object. Thus, subsequent instantiations of the building object will reflect the recorded changes, so that changes to the user-customized building are continuous over multiple PVP matches.

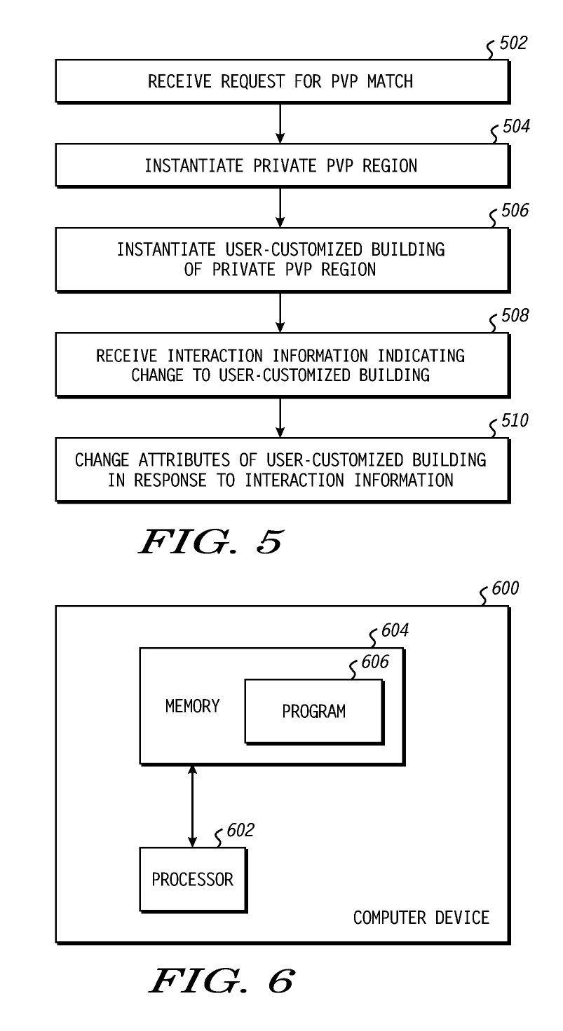

Referring to FIG. 5, a flow diagram of an embodiment of a method of initiating a player-versus-player match in a network game environment is illustrated. At block 502, a request to start a PVP match is received at a game server via a network. At block 504, in response to the request a private PVP region of a publicly accessible game environment is instantiated. At block 506, a user-customized building is instantiated at the private PVP region. The user-customized building is based on a set of attributes that have been customized by a game participant.

At block 508, interaction information is received at the game server during the PVP match. The interaction information represents information communicated by a client game program indicating a change to the instantiated user-customized building resulting from a player interaction. For example, during the PVP a player can provide input information indicating that a game character associated with the player has struck a wall of the user-customized building. The client game program can indicate this input information to the game server. In response, the game server can determine the strike has caused damage to the wall, resulting in a change to the attributes of the in-game building. Accordingly, at block 510 the attributes of the user-customized building are changed in response to the interaction information. This can result in changes to in the displayed appearance of the user-customized building, changes in the layout, and the like, thereby improving the immersiveness of the game experience.

FIG. 6 shows a block diagram of a particular embodiment of a computer device 600. The computer device 600 can correspond to a client device or game server of FIG. 1, or both. The computer device 600 includes a processor 602 and a memory 604. The computer device 600 can include additional hardware, such as a network interface (not shown) to interface with the wide area network 150, a display device (not shown) to display a GUI to modify the attributes illustrated at FIG. 2, and the like.

The memory 604 is a computer readable medium, and can be volatile memory, such as random access memory (RAM), or non-volatile memory, such as flash memory or a hard disk. The memory 604 stores a program 606 that includes instructions to manipulate the processor 602 in order to implement one or more of the methods described herein.

Other embodiments, uses, and advantages of the disclosure will be apparent to those skilled in the art from consideration of the specification and practice of the disclosure disclosed herein. The specification and drawings should be considered exemplary only, and the scope of the disclosure is accordingly intended to be limited only by the following claims and equivalents thereof.

What is claimed is:

1. A method, comprising:
receiving a first request to enter a player-versus-player mode of a network game;
in response to receiving the first request:
communicating first game information representative of a private portion of publicly accessible game environment, the private portion including a first in-game building, the first in-game building associated with a first plurality of attributes based on configuration information selected by a first user; and
initiating a player-versus-player match at the private portion of the publicly accessible game environment.

2. The method of claim 1, further comprising:
receiving game interaction information associated with the player-vs.-player match;
changing a first attribute of the first plurality of attributes in response to the game interaction information; and
communicating second game information to update a display of the in game building in response to changing the first attribute.

3. The method of claim 1, wherein communicating first game information comprises communicating first game information representing an instantiation of the first in-game building at the private portion of the in-game environment.

4. The method of claim 3, further comprising terminating the instantiation of the first in-game building in response to receiving a request to terminate the player-versus-player match.

5. The method of claim 1, wherein the private portion includes a second in-game building associated with a second plurality of attributes based on configuration information selected by a second user.

6. The method of claim 5, wherein the first user and the second user are associated with opposite sides of the player-versus-player match.

7. The method of claim 5, wherein the first in-game building is associated group of game participants, and the second in-game building is associated with a second group of game participants.

8. The method of claim 1, wherein a layout of the first in-game building is based on the first plurality of attributes.

9. The method of claim 1, wherein an in-game weapon associated with the first in-game building is based on the first plurality of attributes.

10. The method of claim 1, wherein the first in-game building represents a copy of a second in-game building, the second in-game building instantiated in a public portion of the game environment.

11. A computer readable medium physically embodying a computer program comprising a plurality of instructions to manipulate a processor, the plurality of instructions comprising instructions to:
receive a first request to enter a player-versus-player mode of a network game;
in response to receiving the first request:
communicate first game information representative of a private portion of publicly accessible game environment, the private portion including a first in-game building, the first in-game building associated with a first plurality of attributes based on configuration information selected by a first user; and
initiate a player-versus-player match at the private portion of the publicly accessible game environment.

12. The computer readable medium of claim 11, wherein the program of instructions further comprise instructions to:
receive game interaction information associated with the player-vs.-player match;
change a first attribute of the first plurality of attributes in response to the game interaction information; and
communicate second game information to update a display of the in game building in response to changing the first attribute.

13. The computer readable medium of claim 11, wherein the instructions to communicate first game information comprise instructions to communicate first game information representing an instantiation of the first in-game building at the private portion of the in-game environment.

14. The computer readable medium of claim 13, wherein the plurality of instructions further comprise instructions to terminating the instantiation of the first in-game building in response to receiving a request to terminate the player-versus-player match.

15. The computer readable medium of claim 11, wherein the private portion includes a second in-game building associated with a second plurality of attributes based on configuration information selected by a second user.

16. The computer readable medium of claim 15, wherein the first user and the second user are associated with opposite sides of the player-versus-player match.

17. The computer readable medium of claim 15, wherein the first in-game building is associated group of game participants, and the second in-game building is associated with a second group of game participants.

18. The computer readable medium of claim 11, wherein a layout of the first in-game building is based on the first plurality of attributes.

19. The computer readable medium of claim 11, wherein an in-game weapon associated with the first in-game building is based on the first plurality of attributes.

20. The method of claim 11, wherein the first in-game building represents a copy of a second in-game building, the second in-game building instantiated in a public portion of the game environment.
